(19) United States
(12) Patent Application Publication
(10) Pub. No.: US 2008/0162429 A1
(43) Pub. Date: Jul. 3, 2008

(54) SEARCH FOR AN ARCHIVED QUERY

(76) Inventor: T. Reghu Ram, Nagercoil (IN)

Correspondence Address: SAP AG, 3410 HILLVIEW AVENUE, PALO ALTO, CA, 94304, US

(21) Appl. No.: 11/617,720

(22) Filed: Dec. 29, 2006

(51) Int. Cl. G06F 7/06

(52) U.S. Cl. 707/3; 707/E17.014

(57) ABSTRACT

A system and method for inputting a query and performing a first search on the query based on a first set of results. Further analyzing the first set of results based on a first set of rules. Archiving the query based on the first set of results as an archived query and performing a second search of the archived query based on a second set of rules to obtain a second set of results. The output of the second set of results of the query is provided.

### FIELD OF INVENTION

Embodiments of invention generally relates to the field of searching in a database and more particularly, to a system and method to improving search for an archived query.

### BACKGROUND

The ability to efficiently share and retrieve information on a worldwide scale has become increasingly important as businesses and organizations become more globalized. Computers are widely used to store and retrieve information, the field of storing and retrieving computerized data through the use of Search Engine relates to internet, the world wide web, an intranet of local systems and/or any combination of database thereof. As the Internet grows to more than a billion documents, these databases will grow respectively. In typical Internet Search Engine designs, Hash techniques, B-tree Indexes, sorted lists, and variations thereon are the accepted approaches. The Search Engine may be used to locate, find, compare, and track data as it relates to documents (including files, images, objects, programs and other data in various forms referred herein as a document) in the System(s).

The database searched by the search engine provides an output as per inputted query. The query can be a combination such as numerical, alphanumerical, character, and/or word.

Further, the output of the inputted query searched by the search engine does not provide automatic search or archiving the outputted search result and/or searching the inputted query automatically in different specified database in given time span.

### SUMMARY OF INVENTION

Embodiments of the invention are generally directed to a system and method for inputting a query and performing a first search on the query based on a first set of results. Further analyzing the first set of results based on a first set of rules. Archiving the query based on the first set of results as an archived query and performing a second search of the archived query based on a second set of rules to obtain a second set of results. The output of the second set of results of the query is provided.

### BRIEF DESCRIPTION OF THE DRAWINGS

A better understanding of an embodiments of the invention is illustrated by an example, and not by way of limitation, can be obtained from the following detailed description in conjunction with the following drawings, in which:

FIG. 1 is a flow diagram of a method illustrating an embodiment of the invention.

FIG. 2 is a flow chart exemplary of an embodiment of the invention.

FIG. 3 is a block diagram illustrating an embodiment of the invention.

### DETAILED DESCRIPTION

The output of the inputted query searched by the search engine does not provide automatic search or archiving the outputted search result and/or searching the inputted query automatically in different specified database in given time span. An embodiment to solve this problem is by inputting a query and performing a first search on the query based on a first set of results. Further analyzing the first set of results based on a first set of rules. Archiving the query based on the first set of results as an archived query and performing a second search of the archived query based on a second set of rules to obtain a second set of results. The output of the second set of results of the query is provided.

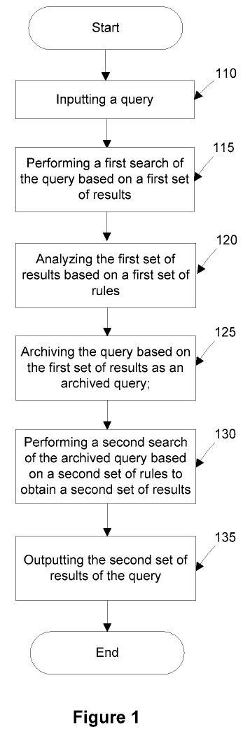

FIG. 1 is a flow diagram of a method illustrating an embodiment of the invention. A process block 110, a query is inputted to searching a database, the database may be selected from a combination of resources such as internet, intranet or stand alone computers to retrieve relevant data as per the inputted query. The query may be of any combination of keywords such as numerical, alphanumerical, character, or word. Those skilled in the art will understand from reading the following detail description that searching the database is performed by a search module and the database may include commercial search engines such as Google®, Yahoo®, or MSN®.

At process block 115, a first search of the query based on a first set of results is performed. The first set of results may be of any combination and may include null search results or a plurality of search results. At process block 120, the first set of results based on a first set of rules is analyzed. The Inputted query as in 110 may be searched by a search module by performing a first search of the query based on a first set of results as in 115 is analyzed. The results analyzed may include search results, null search results, threshold limit for a plurality of search results, remote device, stand alone computer, internet, intranet, or combination thereof.

At process block 125, archiving the query based on the first set of results as an archived query. Archiving the query may include logically archiving the query. At process block 130, a second search of the archived query based on a second set of rules to obtain a second set of results is performed. The second set of rules may be of any combination including editing the archived query, a time frame, or location of search. The second set of results may be of any combination including providing the second set of results for the second search of the query in the database, providing the second set of results for the second search of the query based on the first set of rules, or providing the second set of results for the search of the query based on the second set of rules. The second set of results may further be a combination of results having the threshold limit for a plurality of search results. Alternatively, the second set of results may be a combination of results having results as per the archived query. At process block 135, the second set of results of the query is outputted. The query from the second set of results may again be edited, searched in different database, archived, or a combination thereof as per the requirement of a new search.

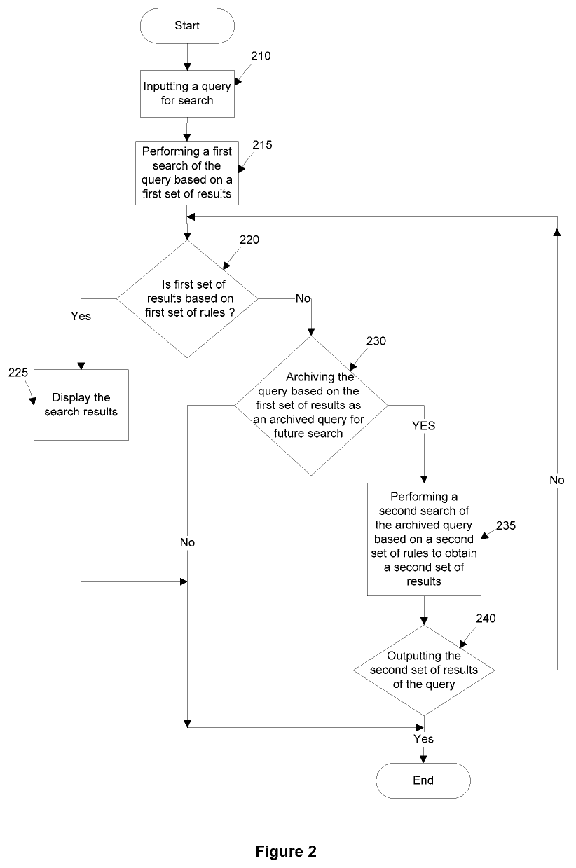

FIG. 2 is a flow chart exemplary of an embodiment of the invention. At process block 210, a query for searching is inputted for performing a first search of the query based on a first set of results as in 215. The search may be performed in a database and the database may include a combination of resources such as internet, intranet or stand alone computers to retrieve relevant data. The query may be of any combination of keywords including numerical, alphanumerical, character, or word. Those skilled in the art will understand from reading the following detail description that searching the database is performed by a search module and the database may include commercial search engines such as Google®, Yahoo®, or MSN®. The first set of rules may be of any combination including null search results or threshold limit for a plurality of search results. The rules may be of any combination and the number of rules applied may vary. At decision block 220, first set of results based on first set of rules is checked. The first set of rules may be of any combination including null search results or threshold limit for a plurality of search results. The rules may be of any combination and the number of rules applied may vary, also the threshold is a user defined limit for number of desired search results. The threshold is a user defined limit for number of desired search results. When the first set of results is based on first set of rules as in 220, display the search results as in process block 225. When the first set of results is not based on first set of rules as in process block 220, archive the query based on the first set of results as an archived query for future search as in 230. Archiving the query may include logically archiving the query.

At process block 235, a second search of the archived query based on a second set of rules to obtain a second set of results is performed. The second set of rules may be of any combination including editing the archived query, a time frame, or location of search as per the user specification. The time frame may be of any combination such as duration of minutes, specified duration of number of hours, days or months as per the user specification. The second set of results may be of any combination including providing the second set of results for the second search of the query in the database, providing the second set of results for the second search of the query based on the first set of rules, providing the second set of results for the search of the query based on the second set of rules, second set of results may further be a combination of results having the threshold limit for a plurality of search results, or may be a combination of results having results as per the archived query.

At decision bock 245, output the second set of results of the query. The query from the second set of results may again be edited, searched in different database, archived, or a combination thereof as per the requirement of new search.

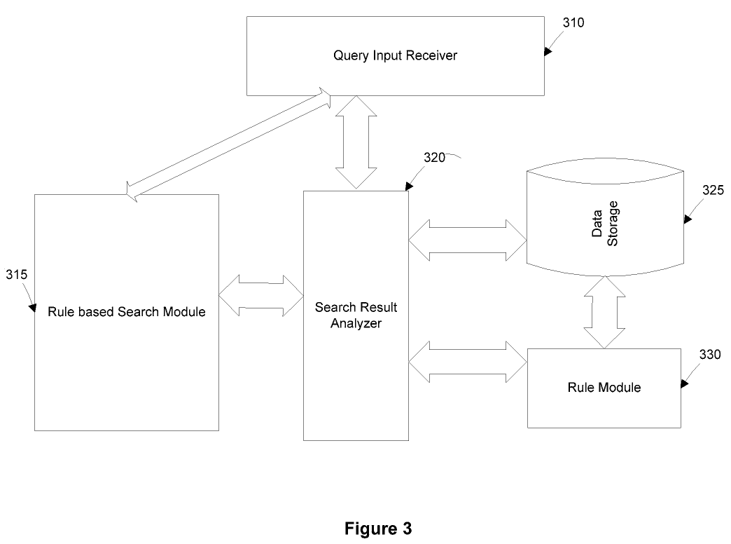

FIG. 3 is a block diagram illustrating an embodiment of the invention. A query input receiver 310 may be coupled to a rule based search module 315, and search result analyzer 320. The rule based search module 315 may be coupled alternatively to the query input receiver 310, and the search result analyzer 320. The search result analyzer 320 may be coupled alternatively to the query input receiver 310, the rule based search module 315, data storage 325, or rule module 330. The data storage 325 may be coupled alternatively to the search result analyzer 320 and the rule module 330. The Rule module 330 may be coupled alternatively to the search result analyzer 320 and the data storage 325.

The query may be of any combination of keywords including numerical, alphanumerical, character, or word. The rules in the rule module 330 and rules based search module 315 may be of any combination including null search results, or threshold limit. The threshold may be a user defined limit for number of desired search results. The rule module 330 may be logically stored but not limited to data storage 325.

Those skilled in the art will understand from reading the following detail description that rule based search module 315 may search in a database and may not be limited to Google®, Yahoo®, or MSN®. The database may be selected from a combination of resources such as internet, intranet or stand alone computers to retrieve relevant data as per the query input receiver 310. The data storage 325 archives the results from search result analyzer 320 and rule module 330 as per the specified rules. Archiving the query includes logically archiving the query in the data storage 325. The rules may be of any combination includes editing the archived query, a time frame, or location of search. The search result analyzer 320 may be selected from a combination of results with respect to the rule based search module 315, rule module 330, data storage 325, or query input receiver.

Elements of embodiments of the present invention may also be provided as a machine-readable medium for storing the machine-executable instructions. The machine-readable medium may include, but is not limited to, flash memory, optical disks, CD-ROMs, DVD ROMs, RAMs, EPROMs, EEPROMs, magnetic or optical cards, or other type of machine-readable media suitable for storing electronic instructions.

It should be appreciated that reference throughout this specification to one embodiment or an embodiment means that a particular feature, structure or characteristic described in connection with the embodiment is included in at least one embodiment of the present invention. These references are not necessarily all referring to the same embodiment. Furthermore, the particular features, structures or characteristics may be combined as suitable in one or more embodiments of the invention.

What is claimed is:

1. A method comprising:
inputting a query;
performing a first search of the query based on a first set of results;
analyzing the first set of results based on a first set of rules;
archiving the query based on the first set of results as an archived query;
performing a second search of the archived query based on a second set of rules to obtain a second set of results; and
outputting the second set of results of the query.

2. The method of claim 1, wherein the second set of rules comprises editing the archived query.

3. The method of claim 1, wherein the query comprises a query in a database.

4. The method of claim 3, further comprising providing the second set of results for the second search of the query in the database.

5. The method of claim 1, further comprising providing the second set of results for the second search of the query based on the first set of rules.

6. The method of claim 1, further comprising providing the second set of results for the search of the query based on the second set of rules.

7. The method of claim 1, wherein the first set of rules comprises null search results.

8. The method of claim 1, wherein the first set of rules comprises a threshold limit for a plurality of search results obtained.

9. The method of claim 8, wherein the second set of results comprises a combination of results having the threshold limit for a plurality of search results.

10. The method of claim 8, wherein the second set of results comprises a combination of results having results as per the archived query.

11. The method of claim 1, wherein the second set of rules comprises a time frame.

12. The method of claim 1, wherein the second set of rules comprises a location of search.

13. An article of manufacture, comprising:
an electronically accessible medium including instructions, that when executed by a processor, cause the processor to:
inputting a query;
performing a first search of the query based on a first set of results;
analyzing the first set of results based on a first set of rules;
archiving the query based on the first set of results as an archived query;
performing a second search of the archived query based on a second set of rules to obtain a second set of results; and
outputting the second set of results of the query.

14. The article of claim 13, wherein the query comprises a query in a database.

15. The article of claim 13, wherein the first set of rules comprises null search results.

16. The article of claim 13, wherein the first set of rules comprises a threshold limit for a plurality of search results obtained.

17. The article of claim 16, wherein the second set of results comprises a combination of results having the threshold limit for a plurality of search results.

18. The article of claim 16, wherein the second set of results comprises a combination of results having results as per the archived query.

19. A system comprising:
a query input receiver;
a rule based search module coupled to the query input receiver;
a search result analyzer coupled to the query input receiver and the rule based search module;
a data storage coupled to the search result analyzer; and
a rule module coupled to the search result analyzer and the data storage.
